(19) United States
(12) Patent Application Publication
(10) Pub. No.: US 2019/0188720 A1
(43) Pub. Date: Jun. 20, 2019

(54) SYSTEMS AND METHODS FOR ENHANCED AUTHORIZATION PROCESSES

(71) Applicant: MASTERCARD INTERNATIONAL INCORPORATED, Purchase, NY (US)

(72) Inventors: Kyle Williams, Wentzville, MO (US); David J. Senci, Troy, IL (US); Michelle L. Hafner, Chesterfield, MO (US)

(21) Appl. No.: 15/843,251

(22) Filed: Dec. 15, 2017

(51) Int. Cl. G06Q 20/40

(52) U.S. Cl. CPC G06Q 20/4016; G06F 17/30964

(57) ABSTRACT

An authorization system for enhancing online authorization processes by centrally storing historical authorization data and analyzing the historical authorization data in real-time for a transaction is provided. The authorization system includes at least one authorization computing device. The authorization system is configured to collect historical transaction data associated with a user account, store the historical transaction data that includes historical authorization data, parse the historical transaction data, and extract the historical authorization data from the historical transaction data. The authorization system is also configured to compile the historical authorization data, build an authorization table using a stored user profile, and continuously update the authorization table using the historical authorization data. The authorization system is further configured to receive an authorization data request from a requestor, compare the authorization data request to the stored user profile, generate an authorization data response, and transmit the authorization data response to the requestor.

### BACKGROUND

The field of the disclosure relates generally to enhancing online authorization processes, and more specifically, to network-based systems and methods for improved authorizing of online transactions by centrally storing historical authorization data by account identifier and device identifier, analyzing the historical authorization data in real-time for a particular transaction, and electronically providing a richer data set of historical authorization data to a requesting party for the particular transaction for improved fraud analysis.

At least some known credit/debit card purchases involve fraudulent activity. Online payment transactions pose especially unique challenges for detecting fraud. Fraudulent payment transactions present liability issues to one or more parties involved in the transaction, such as an issuer bank, a merchant, and/or a payment processing network used for authorizing payment card transactions initiated by a user. As such, these parties are interested in fraud detection, or the ability to analyze the data surrounding payment card transactions before authorizing the transaction. For example, in online transactions through a merchant web site or “card-not-present” transactions, the merchant party involved in the transaction may assume initial liability for certain aspects of the transaction unless, for example, certain risk-mitigating steps are taken.

These risk-mitigating steps may involve authentication of the user and/or a fraud assessment prior to authorizing the payment transaction. For example, some merchants will attempt to determine whether a suspect consumer that is attempting to complete a purchase using a payment card through the merchant's website is a legitimate cardholder with authority to make said purchase using said payment card. One way the merchant may attempt to confirm that the suspect consumer is the legitimate cardholder is by looking at the transaction history of the legitimate cardholder through the merchant's website. In other words, if the legitimate cardholder has made other similar purchases in the past via the same website, then the merchant may score this particular transaction as low risk, and thus, may approve the transaction. Of course, by so doing, the merchant is accepting certain risks that the suspect consumer is not really the legitimate cardholder, especially in those cases where the transaction history of the cardholder through the merchant's website is very limited. Moreover, in those cases where the legitimate cardholder has never made a purchase using this particular payment card through the merchant's website, then the merchant is at an extreme disadvantage when trying to assess potential fraud because they have no such historical transaction data to rely on.

Accordingly, an enhanced authorization system is needed that better centralizes the collection and storage of historical authorization data, stores said data by account identifier and device identifier, and provides a richer data set of historical authorization data to a requesting merchant for improved fraud analysis.

### BRIEF DESCRIPTION

In one aspect, an authorization system for enhancing online authorization processes by centrally storing historical authorization data and analyzing the historical authorization data in real-time for a particular transaction is provided. The authorization system includes at least one authorization computing device that includes a processor communicatively coupled to a memory and is configured to collect historical transaction data associated with a user account, store the historical transaction data within a database, wherein the transaction data includes historical authorization data, parse the historical transaction data, and extract the historical authorization data from the historical transaction data. The authorization computing device is also configured to compile the historical authorization data, and build an authorization table using a stored user profile, wherein the stored user profile includes the historical authorization data that includes at least one of account information and a device identifier, and wherein the stored user profile is built using at least one of the account information and the device identifier. The authorization computing device is further configured to continuously update the authorization table using the historical authorization data, receive an authorization data request from a requestor, compare the authorization data request to the stored user profile, generate, in response to the authorization data request, an authorization data response, and transmit the authorization data response to the requestor.

In another aspect, a computer-implemented method for enhancing online authorization processes by centrally storing historical authorization data and analyzing the historical authorization data in real-time for a particular transaction is provided. The method is performed using at least one authorization computing device that includes at least one processor in communication with at least one memory device. The method includes collecting historical transaction data associated with a user account, storing the historical transaction data within a database, wherein the historical transaction data includes historical authorization data, parsing the historical transaction data, and extracting the historical authorization data from the historical transaction data. The method also includes compiling the historical authorization data, and building an authorization table using a stored user profile, wherein the stored user profile includes the historical authorization data that includes at least one of account information and a device identifier, and wherein the stored user profile is built using at least one of the account information and the device identifier. The method further includes continuously updating the authorization table using the historical authorization data, receiving an authorization data request from a requestor, comparing the authorization data request to the stored user profile, generating, in response to the authorization data request, an authorization data response, and transmitting the authorization data response to the requestor.

In yet another aspect, a non-transitory computer readable medium that includes executable instructions for enhancing online authorization processes by a centrally storing historical authorization data and analyzing the historical authorization data in real-time for a particular transaction is provided. When the computer executable instructions are executed by an authorization computing device that includes at least one processor in communication with at least one memory device, the computer executable instructions cause the authorization computing device to collect historical transaction data associated with a user account, store the historical transaction data within a database, wherein the transaction data includes historical authorization data, parse the historical transaction data, and extract the historical authorization data from the historical transaction data The computer executable instructions also cause the authorization computing device to compile the historical authorization data, and build an authorization table using a stored user profile, wherein the stored user profile includes the historical authorization data that includes at least one of account information and a device identifier, and wherein the stored user profile is built using at least one of the account information and the device identifier. The computer executable instructions further cause the authorization computing device to continuously update the authorization table using the historical authorization data, receive an authorization data request from a requestor, compare the authorization data request to the stored user profile, generate, in response to the authorization data request, an authorization data response, and transmit the authorization data response to the requestor.

### BRIEF DESCRIPTION OF THE DRAWINGS

FIGS. 1-7 show example embodiments of the methods and systems described herein.

FIG. 1 is a schematic diagram illustrating an example multi-party payment card processing system for enabling payment-by-card transactions between merchants, users, and issuers.

FIG. 2 is a simplified block diagram of an example system used for enhancing online authorization processes by a centrally storing historical authorization data and analyzing the historical authorization data in real-time for a particular transaction.

FIG. 3 illustrates an example configuration of a client system shown in FIG. 2, in accordance with one embodiment of the present disclosure.

FIG. 4 illustrates an example configuration of a server system shown in FIG. 2, in accordance with one embodiment of the present disclosure.

FIG. 5 is a flow chart of a process for enhancing online authorization processes by a centrally storing historical authorization data and analyzing the historical authorization data in real-time for a particular transaction using the system shown in FIG. 2.

FIG. 6 is a diagram of components of one or more example computing devices that may be used in the system shown in FIG. 2.

FIG. 7 illustrates an example configuration of an authorization computing device, in accordance with one embodiment of the present disclosure.

### DETAILED DESCRIPTION

The following detailed description illustrates embodiments of the disclosure by way of example and not by way of limitation. The description clearly enables one skilled in the art to make and use the disclosure, describes several embodiments, adaptations, variations, alternatives, and uses of the disclosure, including what is presently believed to be the best mode of carrying out the disclosure of the systems and methods for enhanced fraud detection by a merchant while authorizing an online payment card transaction by requesting, receiving and analyzing a richer set of historical authorization data in real-time for an account identifier or device identifier used in the transaction. As defined herein, real-time relates to the authorization system processing data within a short period of time (e.g., from about milliseconds to minutes, or hours, as opposed to a matter of days) so that the data output and/or input is available virtually immediately.

One risk-mitigating step that can be used to address fraudulent payment card transactions is user authentication or fraud detection. These steps can be performed by different parties involved in the payment process. For example, a merchant involved in an online payment transaction can score the transaction for fraud purposes. In addition, the payment processor, the card issuer bank and/or the acquirer bank can also analyze such transactions. In these cases of trying to detect fraud, the parties may examine certain data associated with the online transaction to determine if the source (e.g., suspect consumer) of the transaction is the authorized user of the payment card or payment account. During such authentication, the suspect consumer (i.e., the person attempting to perform the payment card transaction with the merchant) may be presented with an authentication challenge, sometimes called a “step-up challenge.” This step-up challenge generally requires the suspect consumer to provide a password or a passcode from a second factor device before the transaction will be processed. By obtaining this additional factor from the suspect consumer, the likelihood of the suspect consumer being a fraudulent consumer is reduced. However, this extra step presents an interruptive inconvenience, a barrier, or an interference to at least some legitimate consumers and subsequently causes at least some consumers to abandon legitimate transactions. These abandonments result in lost revenues to many parties, such as the merchant, the merchant acquirer, and the issuer. Accordingly, at least some of these parties would prefer to determine whether an online transaction is fraudulent or not without having to submit a step-up challenge to the consumer. Of course, by doing so, at least one or more of these parties may be increasing their risk for experiencing fraud and incurring losses.

In the example embodiment, an authorization system and, more particularly, at least one authorization computing device, associated with or in communication with a payment network, is configured to provide an enhanced authorization service for an online payment transaction by electronically providing, in real-time, a richer data set of historical authorization data to a requesting party (e.g., a merchant) for an account identifier and/or a device identifier involved in the payment transaction so that the merchant is able to better determine whether the suspect consumer initiating the transaction is the legitimate cardholder. When a user is enrolled in the service, the authorization computing device may collect some account information of the user, such as preliminary authentication, an account identifier (e.g., a primary account number (PAN)), digital signature, and/or biometric signatures, and one or more device identifiers. The account information and the device identifier are stored by the authorization computing device as a user profile. The authorization computing device uses the stored user profile to build an authorization table that enables easy access to the stored user profile. In the example embodiment, the authorization computing device is configured to receive and/or collect historical transaction data associated with the identified user account and store the historical transaction data within a database. The historical transaction data includes historical authorization data, which may include an authorization date and a clearing date for any given prior transaction. The authorization computing device is also configured to parse the historical transaction data, extract the historical authorization data, compile the historical authorization data, store the historical authorization data, and continuously update the authorization table using the historical authorization data.

In some embodiments, the historical transaction data, including the historical authorization data, is anonymized and aggregated (e.g., by a merchant computing device) prior to receipt by the authorization computing device (i.e., no personally identifiable information (PII) is received by the authorization computing device). In other embodiments, the authorization computing device may be configured to receive the historical transaction data that is not yet anonymized and/or aggregated, and thus may be configured to anonymize and aggregate the historical transaction data. In such embodiments, any PII received by the authorization computing device is received and processed in an encrypted format, or is received with the consent of individuals with which the PII is associated. In situations in which the systems discussed herein collect personal information about individuals including users and/or merchants, or may make use of such personal information, individuals may be provided with an opportunity to control whether such information is collected or to control whether and/or how such information is used. In addition, certain data may be processed in one or more ways before it is stored or used, so that personally identifiable information is removed.

The authorization computing device is further configured to calculate, using the historical authorization data, a first authorization date (e.g., the first time a transaction was authorized for the account identifier), a first clearing date (e.g., the first time a transaction was cleared for the account identifier), a most recent authorization date (e.g., the last time a transaction was authorized for the account identifier), a most recent clearing date (e.g., the last time a transaction was cleared for the account identifier), a first fraudulent activity date (e.g., the first time a transaction was flagged as fraudulent for the account identifier), and a most recent fraudulent activity date (e.g., the last time a transaction was flag as fraudulent for the account identifier), and store such dates in the authorization table.

The authorization computing device is also configured to calculate, using the historical authorization data, a first authorization date for a device identifier (e.g., the first time a transaction was authorized for the account identifier and the device identifier), a first clearing date for the device identifier (e.g., the first time a transaction was cleared for the account identifier and the device identifier), a most recent authorization date for the device identifier (e.g., the last time a transaction was authorized for the account identifier and the device identifier), a most recent clearing date for the device identifier (e.g., the last time a transaction was cleared for the account identifier and the device identifier), a first fraudulent activity date for the device identifier (e.g., the first time a transaction was flagged as fraudulent for the account identifier and the device identifier), and a most recent fraudulent activity date for the device identifier (e.g., the last time a transaction was flag as fraudulent for the account identifier and the device identifier), and store such dates in the authorization table.

The stored historical authorization data in the authorization table are easily and quickly retrievable enabling real-time responses to requestors of such data. The authorization computing device may also update the authorization table every time transaction data associated with a stored user profile is received. As defined herein, real-time relates to retrieval of data and generation of responses within a short period of time (e.g., from about milliseconds to minutes, or hours, as opposed to a matter of days) so that the data output and/or input is available virtually immediately.

In the example embodiment, the authorization computing device is configured to receive an authorization data request from a requestor (e.g., a merchant and/or issuer), wherein the authorization data request may include account information, and device identifier. The authorization computing device is also configured to receive a request for information stored in the authorization table in the form of single call out (e.g., the requestor sends a request for a single account) or in the form of a batch (e.g., the requestor sends a request that includes a list of accounts).

Once the authorization data request is received, the authorization computing device compares the authorization data request to the stored user profile. More specifically, authorization computing device uses the account identifier and/or the device identifier to perform a look up to retrieve the stored user profile. If the authorization data request and the stored user profile match, the authorization computing device transmits in real-time to the requestor an authorization data response that may include the first authorization date, the first clearing date, the most recent authorization date, the most recent clearing date, the first authorization date for the device identifier, the first clearing date for the device identifier, the most recent authorization date for the device identifier, and the most recent clearing date for the device identifier.

If the authorization data request and the stored user profile do not match, the authorization computing device may transmit in real-time to the requestor an authorization data response indicating that there was no match. The authorization computing device provides authorization data responses that indicate whether historical transactions initiated by a user have previously been authorized. In some embodiments, when the authorization computing device determines that the historical transactions have previously been authorized, but have also been part of fraudulent activity, the authorization computing device may include in the authorization data response additional information, such as the first fraudulent activity date, the most recent fraudulent activity date, the first fraudulent activity date for the device identifier, and the most recent fraudulent activity date for the device identifier.

For example, during a payment transaction with a merchant registered for the enhanced authorization service, the user initiates the transaction through a point of sale (POS) device or a website ecommerce gateway, usually associated with a merchant, which is in communication with the authorization computing device. The merchant provides an authorization data request that may include user account information and a user device identifier to the authorization computing device to enable the authorization computing device to identify the corresponding stored user profile. The authorization computing device analyzes the authorization data request to determine whether the transaction initiated by the user, matches a stored user profile. Based on the determination, the authorization computing device may return to the merchant the user's historical authorization data in real-time. Moreover, the authorization computing device may provide the user's historical authorization data to any requestor (e.g., acquirer bank, issuer bank, or the like) registered for the enhanced authorization service. When the authorization computing device determines that the transaction data does not match a stored user profile, the authorization computing device may transmit to the merchant or any other requestor a message indicating that the transaction data does not match a user profile. Thus, the recipient of the message may assess that a no match is indicative of a high risk payment transaction and may decide not to complete the transaction.

In some embodiments, the authorization computing device is configured to generate a risk score for a user profile based on the age of the user's account. For example, a user who has used an account for a long period of time (e.g., the first authorization date was more than one year ago) may have a user profile with a low risk score compared to a user who has used an account for few months (e.g., the first authorization date was three months ago). The authorization computing device may be configured to generate the risk based on the user's historical authorization data and clearing information, such as clearing dates.

The methods and system described herein may be implemented using computer programming or engineering techniques including computer software, firmware, hardware, or any combination or subset. As disclosed above, at least one technical problem with prior systems is that there is a need for an enhanced authorization service. The system and methods described herein address that technical problem. The technical effect of the systems and processes described herein is achieved by performing at least one of the following steps: (a) collecting historical transaction data associated with a user account; (b) storing the historical transaction data within a database, wherein the historical transaction data includes historical authorization data; (c) parsing the historical transaction data; (d) extracting the historical authorization data from the historical transaction data; (e) compiling the historical authorization data; (f) building an authorization table using a stored user profile, wherein the stored user profile includes historical authorization data, wherein the historical authorization data includes at least one of account information and a device identifier, and wherein the stored user profile is built using at least one of the account information and the device identifier; (g) continuously updating the authorization table using the historical authorization data; (h) receiving an authorization data request from a requestor; (i) comparing the authorization data request to the stored user profile; (j) generating, in response to the authorization data request, an authorization data response; and (k) transmitting the authorization data response to the requestor. The resulting technical effect is a more accurate and effective authorization system. This is achieved through a method of using historical authorization data to generate in real-time rich data sets and transmit the rich data sets to requesting parties to facilitate determining the fraud or risk of a payment transaction.

As used herein, the terms “transaction card,” “financial transaction card,” and “payment card” refer to any suitable transaction card, such as a credit card, a debit card, a prepaid card, a charge card, a membership card, a promotional card, a frequent flyer card, an identification card, a gift card, and/or any other device that may hold payment account information, such as mobile phones, smartphones, personal digital assistants (PDAs), key fobs, and/or computers. Each type of transactions card can be used as a method of payment for performing a transaction.

In one embodiment, a computer program is provided, and the program is embodied on a computer-readable medium. In an example embodiment, the system is executed on a single computer system, without requiring a connection to a server computer. In a further example embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, Calif.). In yet a further embodiment, the system is run on a Mac OS® environment (Mac OS is a registered trademark of Apple Inc. located in Cupertino, Calif.). The application is flexible and designed to run in various different environments without compromising any major functionality. In some embodiments, the system includes multiple components distributed among a plurality of computing devices. One or more components are in the form of computer-executable instructions embodied in a computer-readable medium. The systems and processes are not limited to the specific embodiments described herein. In addition, components of each system and each process can be practiced independently and separately from other components and processes described herein. Each component and process can also be used in combination with other assembly packages and processes.

In one embodiment, a computer program is provided, and the program is embodied on a computer-readable medium and utilizes a Structured Query Language (SQL) with a client user interface front-end for administration and a web interface for standard user input and reports. In another embodiment, the system is web enabled and is run on a business entity intranet. In yet another embodiment, the system is fully accessed by individuals having an authorized access outside the firewall of the business-entity through the Internet. In a further embodiment, the system is being run in a Windows® environment (Windows is a registered trademark of Microsoft Corporation, Redmond, Wash.). The application is flexible and designed to run in various different environments without compromising any major functionality.

As used herein, an element or step recited in the singular and preceded with the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

As used herein, the term “database” may refer to either a body of data, a relational database management system (RDBMS), or to both. A database may include any collection of data including hierarchical databases, relational databases, flat file databases, object-relational databases, object oriented databases, and any other structured collection of records or data that is stored in a computer system. The above examples are for example only, and thus are not intended to limit in any way the definition and/or meaning of the term database. Examples of RDBMS's include, but are not limited to including, Oracle® Database, MySQL, IBM® DB2, Microsoft® SQL Server, Sybase®, and PostgreSQL. However, any database may be used that enables the system and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.).

The term processor, as used herein, may refer to central processing units, microprocessors, microcontrollers, reduced instruction set circuits (RISC), application specific integrated circuits (ASIC), logic circuits, and any other circuit or processor capable of executing the functions described herein.

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are for example only, and are thus not limiting as to the types of memory usable for storage of a computer program.

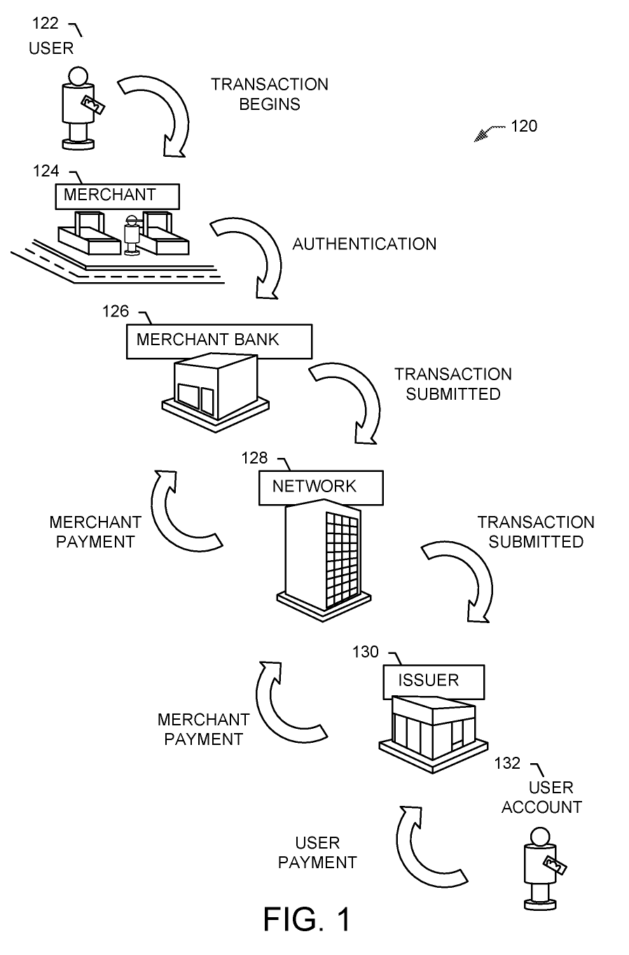

FIG. 1 is a schematic diagram illustrating an example multi-party payment card processing system 120 for enabling payment-by-card transactions between merchants 124, users 122, and issuer 130. Embodiments described herein may relate to a transaction card system, such as a credit card payment system using the Mastercard® interchange network. The Mastercard® interchange network is a set of proprietary communications standards promulgated by Mastercard International Incorporated® for the exchange of financial transaction data and the settlement of funds between financial institutions that are registered with Mastercard International Incorporated®. (Mastercard is a registered trademark of Mastercard International Incorporated located in Purchase, N.Y.).

In the payment card processing system, a financial institution called the “issuer” issues a transaction card or electronic payments account identifier, such as a credit card and/or a debit card, to a consumer or user 122, who uses the transaction card to tender payment for a purchase from a merchant 124. Merchant 124 may be a merchant computing device, a merchant/website server, or the like. To accept payment with the transaction card, merchant 124 must normally establish an account with a financial institution that is part of the financial payment system. This financial institution is usually called the “merchant bank,” the “acquiring bank,” or the “acquirer.” When user 122 tenders payment for a purchase with a transaction card, merchant 124 requests authorization from a merchant bank 126 for the amount of the purchase. The request may be performed over the telephone, but is usually performed through the use of a point-of-sale (POS) terminal, which reads user's 122 account information from a magnetic stripe, a chip, or embossed characters on the transaction card and communicates electronically with the transaction processing computers of merchant bank 126. Alternatively, merchant bank 126 may authorize a third party to perform transaction processing on its behalf. In this case, the POS terminal will be configured to communicate with the third party. Such a third party is usually called a “merchant processor,” an “acquiring processor,” or a “third party processor.”

Using an interchange network 128, computers of merchant bank 126 or merchant processor will communicate with computers of an issuer 130 to determine whether user account 132 associated with user 122 is in good standing and whether the purchase is covered by user's 122 available credit line. Based on these determinations, the request for authorization will be declined or accepted. If the request is accepted, an authorization code is issued to merchant 124.

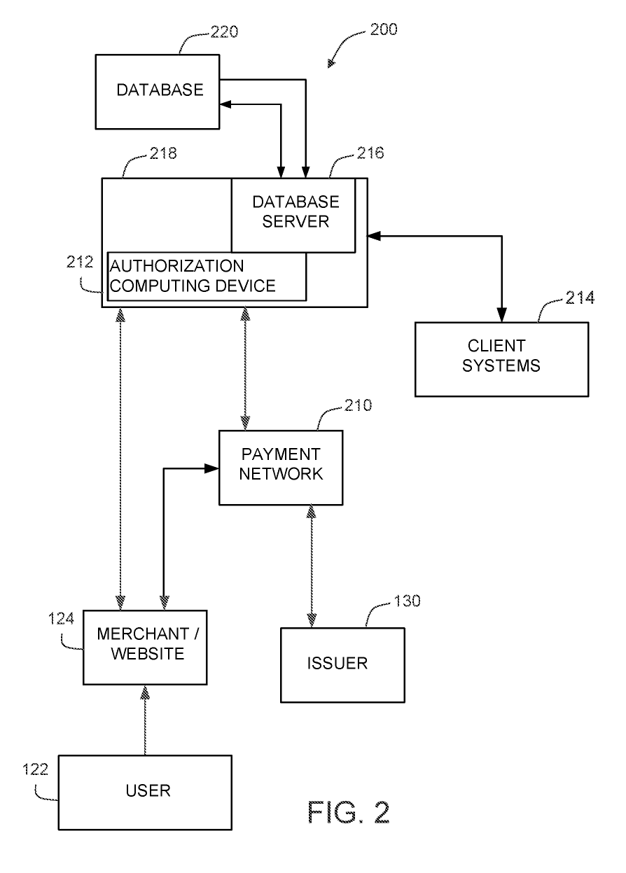

When a request for authorization is accepted, the available credit line of user account 132 is decreased. Normally, a charge for a payment card transaction is not posted immediately to user account 132 because bankcard associations, such as Mastercard International Incorporated®, have promulgated rules that do not allow merchant 124 to charge, or “capture,” a transaction until goods are shipped or services are delivered. However, with respect to at least some debit card transactions, a charge may be posted at the time of the transaction. When merchant 124 ships or delivers the goods or services, merchant 124 captures the transaction by, for example, appropriate data entry procedures on the POS terminal. This may include bundling of approved transactions daily for standard retail purchases. If user 122 cancels a transaction before it is captured, a “void” is generated. If user 122 returns goods after the transaction has been captured, a “credit” is generated. Interchange network 128 and/or issuer 130 stores the transaction card information, such as a category of merchant, a merchant identifier, a location where the transaction was completed, amount of purchase, and a date and time of transaction, in a database 220 (shown in FIG. 2).

After a purchase has been made, a clearing process occurs to transfer additional transaction data related to the purchase among the parties to the transaction, such as merchant bank 126, interchange network 128, and issuer 130. More specifically, during and/or after the clearing process, additional data, such as a time of purchase, a merchant name, a type of merchant, purchase information, user account information, a type of transaction, itinerary information, information regarding the purchased item and/or service, and/or other suitable information, is associated with a transaction and transmitted between parties to the transaction as transaction data, and may be stored by any of the parties to the transaction.

For debit card transactions, when a request for a personal identification number (PIN) authorization is approved by the issuer, user account 132 is decreased. Normally, a charge is posted immediately to user account 132. The payment card association then transmits the approval to the acquiring processor for distribution of goods/services or information, or cash in the case of an automated teller machine (ATM).

After a transaction is authorized and cleared, the transaction is settled among merchant 124, merchant bank 126, and issuer 130. Settlement refers to the transfer of financial data or funds among merchant's 124 account, merchant bank 126, and issuer 130 related to the transaction. Usually, transactions are captured and accumulated into a “batch,” which is settled as a group. More specifically, a transaction is typically settled between issuer 130 and interchange network 128, and then between interchange network 128 and merchant bank 126, and then between merchant bank 126 and merchant 124.

In some embodiments, user 122 registers one or more payment cards with a digital wallet. Having done this, user 122 can interact with a participating online merchant 124. At the check-out stage, online merchant 124 displays a button on the merchant website which user 122 can click on in order to make a payment using the user's digital wallet. Online merchant 124 then redirects the user to a “switch” operated by interchange network 128. Using a cookie located on user's 122 computing device, the “switch” is able to determine which wallet-hosting server hosts a wallet associated with user 122. The switch then establishes a connection between the user's 122 computing device and the appropriate wallet-hosting system, which presents user 122 with a sign-in page (e.g., as a pop-up window), where there is an authentication process (e.g., entry of a pre-agreed password). This log-in process may use the same login credentials (e.g., password) which the user also uses to obtain access to other online banking activities.

The wallet-hosting system then securely transfers the user's payment information to the online merchant's domain. The merchant's domain submits user's 122 payment information to merchant bank 126 for a separate authorization process in which the acquiring domain communicates with issuer 130 to ask the bank to authorize the transaction. Thus, user 122 is not required to enter their card details (except at the stage of initially registering with the wallet-hosting system), and the online transaction process is streamlined with only a single redirection, and consistent branding for the entire payment process, irrespective of the online merchant 124.

In some embodiments, a unique identifier is provided to user 122. The unique identifier is different from user's 122 account number. In these embodiments, interchange network 128 stores the unique identifier in database 220 along with user account 132. When interchange network 128 receives the unique identifier, interchange network 128 determines the associated user account 132 and uses that information in processing the payment transaction.

FIG. 2 is a simplified block diagram of an example system 200 used for enhancing online authorization processes. In the example embodiment, system 200 may be used for performing payment-by-card transactions received as part of processing user transactions. In addition, system 200 is a payment processing system that includes at least one authorization computing device 212 configured to enhance online authorization processes. As described below in more detail, authorization computing device 212 is configured to provide an enhanced authorization service for an online payment transaction by electronically providing, in real-time, a richer data set of historical authorization data to a requesting party, such as merchant 124 (shown in FIG. 1), for an account identifier and/or a device identifier involved in the payment transaction so that merchant 124 is able to better determine whether a suspect consumer initiating the transaction is the legitimate cardholder.

System 200 also includes a database server 216. Authorization computing device 212 and database server 216 may be components of server system 218. Server system 218 may be a server, a network of multiple computing devices, a virtual computing device, or the like. In the example embodiment, client systems 214 are computing devices that include a web browser or a software application to enable client systems 214 to access authorization computing device 212 using the Internet. More specifically, client systems 214 are communicatively coupled to the Internet through many interfaces including, but not limited to, at least one of a network, such as a local area network (LAN), a wide area network (WAN), or an integrated services digital network (ISDN), a dial-up-connection, a digital subscriber line (DSL), a cellular phone connection, and a cable modem. Client systems 214 can be any device capable of accessing the Internet including, but not limited to, a desktop computer, a laptop computer, a personal digital assistant (PDA), a cellular phone, a smartphone, a tablet, a phablet, or other web-based connectable equipment. In the example embodiment, user 122 uses a client system 214 to access a commerce website for merchant 124. In another embodiment, user 122 uses client system 214 to register for an enhanced authorization service.

A database server 216 is communicatively coupled to a database 220 that stores data. In one embodiment, database 220 includes at least one user profile, historical transaction data, historical authorization data, and at least one authorization table. In the example embodiment, database 220 is stored remotely from authorization computing device 212. In some embodiments, database 220 is decentralized. In the example embodiment, a user can access database 220 via client systems 214 by logging onto authorization computing device 212, as described herein.

Authorization computing device 212 is communicatively coupled with payment network 210. Payment network 210 represents one or more parts of payment network 120 (shown in FIG. 1). In the example embodiment, authorization computing device 212 is in communication with one or more computing devices associated with interchange network 128 shown in FIG. 1. In other embodiments, authorization computing device 212 is in communication with one or more computing devices associated with merchant 124, merchant bank 126 (shown in FIG. 1), or issuer 130. In some embodiments, authorization computing device 212 may be associated with, or is part of payment network 120, or in communication with payment network 120. In other embodiments, authorization computing device 212 is associated with a third party and is in communication with payment network 120. In some embodiments, authorization computing device 212 may be associated with, or be part of merchant bank 126, interchange network 128, and issuer 130. In addition, authorization computing device 212 is communicatively coupled with merchant 124. In the example embodiment, authorization computing device 212 is in communication with merchant 124 and client systems 214 via Application Programming Interface (API) calls. Through the API call, merchant 124 and client systems 214 may transmit information to and receive information from authorization computing device 212.

In the example embodiment, authorization computing device 212 is associated with a payment network 210 and is configured to provide an enhanced authorization service. When user 122 is enrolled in the service, authorization computing device 212 may collect some account information of the user, such as preliminary authentication, an account identifier (e.g., a primary account number (PAN)), digital signature, and/or biometric signatures, and one or more device identifiers. The account information and the device identifier are stored by authorization computing device 212 as a user profile within database 220 and/or database server 216. Authorization computing device 212 uses the stored user profile to build an authorization table that enables easy access to the stored user profile. In the example embodiment, authorization computing device 212 is configured to receive and/or collect historical transaction data associated with the identified user account and store the historical transaction data within database 220 and/or database server 216. The historical transaction data includes historical authorization data, which may include an authorization date and a clearing date for any given prior transaction. Authorization computing device 212 is also configured to parse the historical transaction data, extract the historical authorization data, compile the historical authorization data, store the historical authorization data, and continuously update the authorization table using the historical authorization data.

In some embodiments, authorization computing device 212 may be associated with the financial transaction interchange network 128 and may be referred to as an interchange computer system. Authorization computing device 212 may be used for processing transaction data and analyzing such data for finding fraudulent transactions. In addition, at least one of client system 214 may include a computer system associated with an issuer 130 of a transaction card. Accordingly, authorization computing device 212 and client systems 214 may be utilized to process transaction data relating to purchases a user 122 makes utilizing a transaction card processed by interchange network 128 and issued by the associated issuer 130. At least one client system 214 may be associated with a user or a user 122 seeking to process a transaction with at least one of interchange network 128, issuer 130, or merchant 124. In addition, client systems 214 may include POS terminals associated with merchant 124 and used for processing payment transactions. Furthermore, client systems 214 may be used by merchant 124 register and access information associated with at least one user account 132 (shown in FIG. 1).

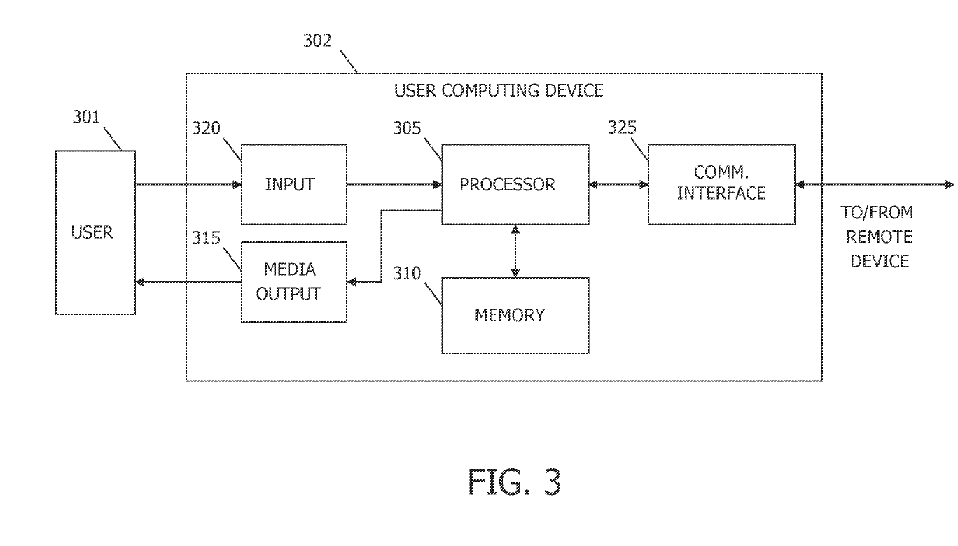

FIG. 3 illustrates an example configuration of a user computing device 302, in accordance with one embodiment of the present disclosure. User computing device 302 is operated by a user 301. User computing device 302 may include, but is not limited to, client systems 214, computing devices associated with merchant 124, and computing devices associated with user 122 (all shown in FIG. 1). User computing device 302 includes a processor 305 for executing instructions. In some embodiments, executable instructions are stored in a memory area 310. Processor 305 may include one or more processing units (e.g., in a multi-core configuration). Memory area 310 is any device allowing information, such as executable instructions and/or transaction data to be stored and retrieved. Memory area 310 may include one or more computer-readable media.

User computing device 302 also includes at least one media output component 315 for presenting information to user 301. Media output component 315 is any component capable of conveying information to user 301. In some embodiments, media output component 315 includes an output adapter (not shown), such as a video adapter and/or an audio adapter. An output adapter is operatively coupled to processor 305 and operatively coupled to an output device such as a display device (e.g., a cathode ray tube (CRT), liquid crystal display (LCD), light emitting diode (LED) display, or “electronic ink” display) or an audio output device (e.g., a speaker or headphones). In some embodiments, media output component 315 is configured to present a graphical user interface (e.g., a web browser and/or a client application) to user 301. A graphical user interface may include, for example, an online store interface for viewing and/or purchasing items, and/or a wallet application for managing payment information. In some embodiments, user computing device 302 includes an input device 320 for receiving input from user 301. User 301 may use input device 320 to, without limitation, select and/or enter one or more items to purchase and/or a purchase request, or to access credential information, and/or payment information. Input device 320 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 315 and input device 320.

User computing device 302 may also include a communication interface 325, communicatively coupled to a remote device, such as authorization computing device 212 (shown in FIG. 2). Communication interface 325 may include, for example, a wired or wireless network adapter and/or a wireless data transceiver for use with a mobile telecommunications network.

Stored in memory area 310 are, for example, computer-readable instructions for providing a user interface to user 301 via media output component 315 and, optionally, receiving and processing input from input device 320. The user interface may include, among other possibilities, a web browser and/or a client application. Web browsers enable users, such as user 301, to display and interact with media and other information typically embedded on a web page or a web site from authorization computing device 212. A client application allows user 301 to interact with, for example, authorization computing device 212. For example, instructions may be stored by a cloud service and the output of the execution of the instructions sent to the media output component 315.

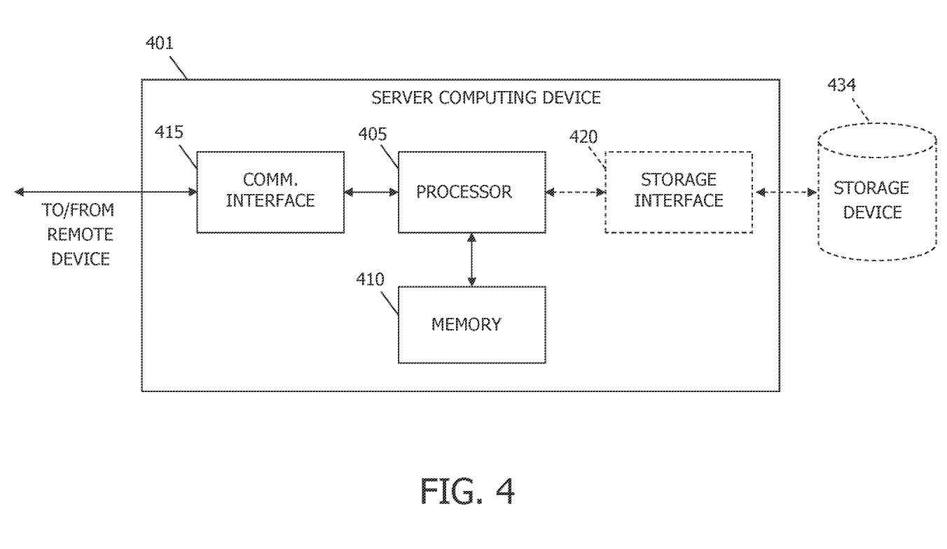

FIG. 4 illustrates an example configuration of a server system 218 shown in FIG. 2, in accordance with one embodiment of the present disclosure. Server computing device 401 may include, but is not limited to, database server 216, merchant/website 124, and authorization computing device 212 (all shown in FIG. 2). Server computing device 401 also includes a processor 405 for executing instructions. Instructions may be stored in a memory 410. Processor 405 may include one or more processing units (e.g., in a multi-core configuration).

Processor 405 is operatively coupled to a communication interface 415 such that server computing device 401 is capable of communicating with a remote device, such as another server computing device 401, client systems 214 (shown in FIG. 2), merchant 124, or authorization computing device 212. For example, communication interface 415 may receive requests from client systems 214 via the Internet.

Processor 405 may also be operatively coupled to a storage device 434. Storage device 434 is any computer-operated hardware suitable for storing and/or retrieving data, such as, but not limited to, data associated with database 220 (shown in FIG. 2). In some embodiments, storage device 434 is integrated in server computing device 401. For example, server computing device 401 may include one or more hard disk drives as storage device 434. In other embodiments, storage device 434 is external to server computing device 401 and may be accessed by a plurality of server computing devices 401. For example, storage device 434 may include a storage area network (SAN), a network attached storage (NAS) system, and/or multiple storage units such as hard disks and/or solid state disks in a redundant array of inexpensive disks (RAID) configuration.

In some embodiments, processor 405 is operatively coupled to storage device 434 via a storage interface 420. Storage interface 420 is any component capable of providing processor 405 with access to storage device 434. Storage interface 420 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 405 with access to storage device 434.

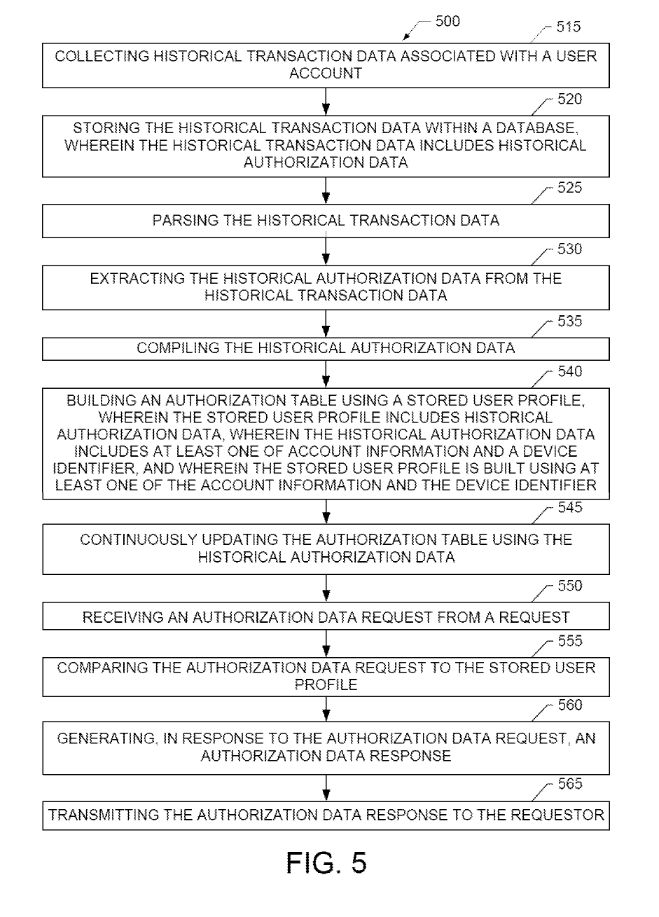

Processor 405 executes computer-executable instructions for implementing aspects of the disclosure. In some embodiments, processor 405 is transformed into a special purpose microprocessor by executing computer-executable instructions or by otherwise being programmed. For example, processor 405 is programmed with the instructions such as are illustrated in FIG. 5.

FIG. 5 is a flow chart of a process 500 for enhancing authorization processes using system 200 shown in FIG. 2. In the example embodiment, process 500 is performed by authorization computing device 212 (shown in FIG. 2).

In the example embodiment, authorization computing device 212 is configured to collect 515 historical transaction data associated with a user account and store 520 the historical transaction data within a database 220 (shown in FIG. 2). The historical transaction data includes historical authorization data, which may include an authorization date and a clearing date for any given transaction. Authorization computing device 212 is also configured to parse 525 the historical transaction data, extract 530 the historical authorization data, compile 535 the historical authorization data, and build 540 an authorization table using a stored user profile that includes the historical authorization data. The historical authorization data includes at least one of user's 122 (shown in FIG. 1) account information and a device identifier. Authorization computing device 212 is configured to build 540 the stored user profile using the account information and/or the device identifier. Authorization computing device 212 is further configured to continuously update 545 the authorization table using the historical authorization data.

In the example embodiment, authorization computing device 212 is configured to receive 550 an authorization data request from a requestor, such as merchant 124 (shown in FIG. 1), wherein the authorization data request may include the account information and the device identifier. In some embodiments, the authorization data request does not include account information. In these embodiments, authorization computing device 212 is configured to determine the account information associated with the account information and/or the device identifier through a lookup in database 220. In the example embodiment, authorization computing device 212 is configured to receive 550 the authorization data request from merchant 124 conducting and/or attempting to conduct a payment transaction with user 122. Merchant 124 may use a user computing device, such as one of client systems 214 (shown in FIG. 2), to transmit the authorization data request to authorization computing device 212.

Once the authorization data request is received, authorization computing device 212 compares 555 the authorization data request to the stored user profile, and in response to the authorization data request, authorization computing device 212 generates 560 an authorization data response. If the authorization data request and the stored user profile match, authorization computing device 212 is configured to generate 560 in real-time an authorization data response that includes a rich data set of historical authorization data. The rich data set may include a first authorization date, a first clearing date, a most recent authorization date, a most recent clearing date, a first fraudulent activity date, and a most recent fraudulent activity date. If the authorization data request and the stored user profile do not match, authorization computing device 212 is configured to generate 560 in real-time an authorization data response indicating that there was no match. After generating the authorization data response, authorization computing device 212 transmits 565 the response to merchant 124. Authorization data responses provided by authorization computing device 212 indicate whether transactions initiated by a user, such as user 122 (shown in FIG. 1), have previously been authorized (e.g., historical authorization data). In some embodiments, when authorization computing device 212 determines that user 122's transactions have been previously been authorized, but have also been part of fraudulent activity, authorization computing device 212 may include in the authorization data response additional information, such as the first fraudulent activity date and the most recent fraudulent activity date.

In some embodiments, authorization computing device 212 may be configured to calculate, using the historical authorization data, a first authorization date, a first clearing date, a most recent authorization date, a most recent clearing date, a first fraudulent activity date, and a most recent fraudulent activity date, and store such dates in the authorization table. Authorization computing device 212 may also be configured to update the authorization table every time the transaction data associated with a stored user profile is received.

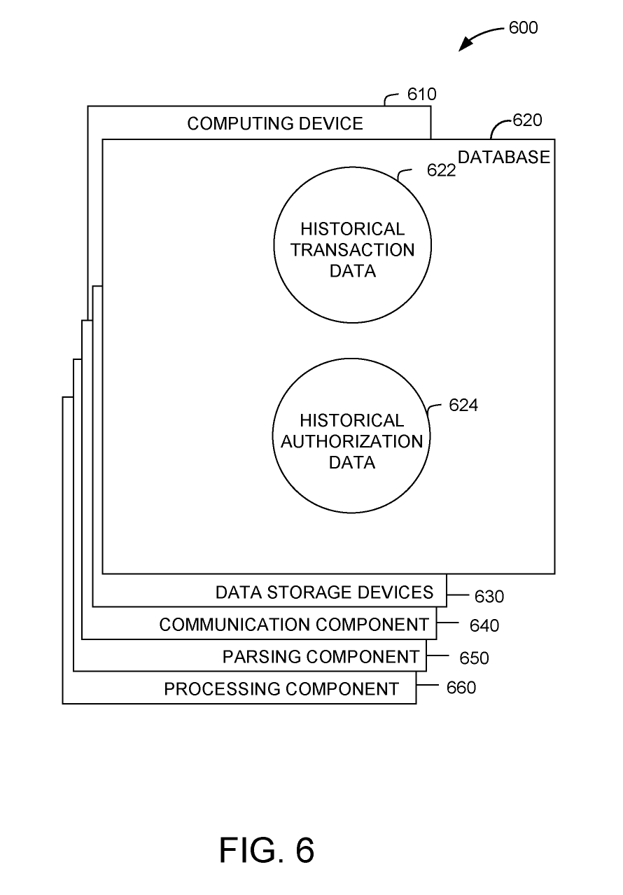

FIG. 6 is a diagram 600 of components of one or more example computing devices that may be used in system 200 shown in FIG. 2. In some embodiments, computing device 610 is similar to authorization computing device 212 (shown in FIG. 2). Database 620 may be coupled with several separate components within computing device 610, which perform specific tasks. In this embodiment, database 620 includes transaction data 622 and historical authorization data 624. In some embodiments, database 620 is similar to database 220 (shown in FIG. 2).

Computing device 610 includes database 620, as well as data storage devices 630. Computing device 610 also includes a communication component 640 for receiving 550 an authorization data request and transmitting 565 one or more authorization data responses (both shown in FIG. 5). Computing device 610 also includes a parsing component 650 for parsing 525 transaction data (shown in FIG. 5), processing component 660 assists with execution of computer-executable instructions associated with the system.

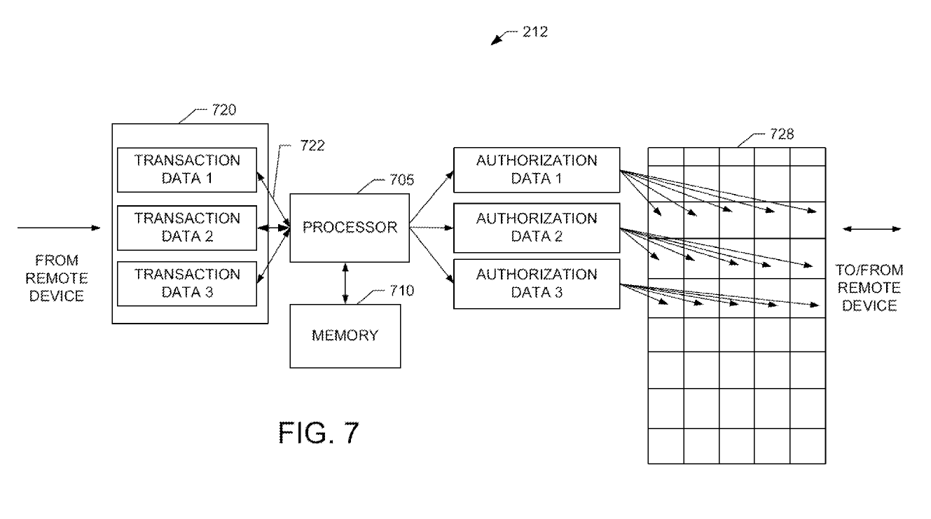

FIG. 7 illustrates an example configuration of an authorization computing device 212 (shown in FIG. 2) for authorizing transactions by analyzing historical authorization data in real-time associated with a user. Authorization computing device 212 may include, but is not limited to, processor 705 for executing instructions. In some embodiments, processor 705 is similar to processor 405 (shown in FIG. 4). In the example embodiment, authorization computing device 212 includes executable instructions are stored in a memory area 710. Processor 705 may include one or more processing units, for example, a multi-core configuration. Memory area 710 is any device allowing information such as executable instructions and/or written works to be stored and retrieved. Memory area 710 may include one or more computer readable media.

Authorization computing device 212 includes a processor 705 for executing instructions. Instructions may be stored in a memory area 710, for example. Processor 705 may include one or more processing units (e.g., in a multi-core configuration) for executing instructions. The instructions may be executed within a variety of different operating systems on the authorization computing device 212, such as UNIX, LINUX, Microsoft Windows®, etc. More specifically, the instructions may cause various data manipulations on data table 728 (e.g., create, read, update, and delete data). It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 705 is operatively coupled to a communication interface (not shown) such that authorization computing device 212 is capable of communicating with a remote device, such as payment network 210 (shown in FIG. 2). For example, communication interface may receive communications from issuer computing device associated with issuer 130 via the Internet, as illustrated in FIG. 2.

Processor 705 may also be operatively coupled to a storage device 720. Storage device 720 is any computer-operated hardware suitable for storing and/or retrieving data. In some embodiments, storage device 720 is integrated in authorization computing device 212. In other embodiments, storage device 720 is external to authorization computing device 212 and is similar to storage device 434 (shown in FIG. 4). For example, authorization computing device 212 may include one or more hard disk drives as storage device 434. In other embodiments, storage device 720 is external to authorization computing device 212 and may be accessed by a plurality of authorization computing device 212. For example, storage device 720 may include multiple storage units such as hard disks or solid state disks in a redundant array of inexpensive disks (RAID) configuration. Storage device 720 may include a storage area network (SAN) and/or a network attached storage (NAS) system.

In some embodiments, processor 705 is operatively coupled to storage device 720 via a storage interface 722. Storage interface 722 is any component capable of providing processor 705 with access to storage device 720. Storage interface 722 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 705 with access to storage device 720.

In certain embodiments, processor 705 is configured to instruct authorization computing device 212. to collect 515 (shown in FIG. 5) historical data associated with a user account. Processor 705 is also configured to instruct authorization computing device 212 to parse 525 (shown in FIG. 5) historical transaction data stored within storage device 720, extract 530 (shown in FIG. 5) authorization data from the transaction data, and to build 540 (shown in FIG. 5) data table 728 (e.g., an authorization table) using a stored user profile that includes the historical authorization data. The historical authorization data includes at least one of user's 122 (shown in FIG. 1) account information and a device identifier. Authorization computing device 212 is configured to build 540 the stored user profile using the account information and/or the device identifier. Processor 705 is further configured to instruct authorization computing device 212 to continuously update 545 (shown in FIG. 5) the authorization table using the historical authorization data

Processor 705 is also configured to instruct authorization computing device 212 to generate 560 (shown in FIG. 5) an authorization data response that may include the first authorization date, the first clearing date, the most recent authorization date, the most recent clearing date, the first fraudulent activity date, and the most recent fraudulent activity date. Processor 705 may also instruct authorization computing device 212 to transmit 565 (shown in FIG. 5) the authorization data response to a requestor.

Processor 705 may be further configured to instruct authorization computing device 212 to calculate, using the authorization data, a first authorization date, a first clearing date, a most recent authorization date, a most recent clearing date, a first fraudulent activity date, and a most recent fraudulent activity date, and store such dates in data table 728. Processor 705 may be also configured to instruct authorization computing device 212 to update data table 728 every time the transaction data associated with a stored user profile is received.

Processor 705 may also instruct authorization computing device 212 to parse 525 transaction data from storage device 720, extract 530 the authorization data, compile 535 the authorization data, and continuously update 545 the authorization table using the authorization data. Additionally or alternatively, processor 705 may be configured to instruct authorization computing device 212 to maintain current records in data table 728. For example, authorization computing device 212 may periodically (e.g., in an hourly and/or daily basis) parse data table 728 to identify outdated records. These records may be in general related to historical authorization data associated with most recent authorizations (e.g., a most recent authorization, a most recent clearing date, a most recent authorization date for the device identifier, and a most recent clearing date for a device identifier) and/or fraudulent activity (most recent fraudulent activity date and a most recent fraudulent activity date for a device identifier).

Memory area 710 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the disclosure has been described in terms of various specific embodiments, those skilled in the art will recognize that the disclosure can be practiced with modification within the spirit and scope of the claims.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial locational differences from the literal language of the claims.

What is claimed is:

1. An authorization system for enhancing online authorization processes by centrally storing historical authorization data and analyzing the historical authorization data in real-time for a particular transaction, the authorization system comprising at least one authorization computing device further comprising a processor communicatively coupled to a memory device, said processor configured to:
collect historical transaction data associated with a user account;
store the historical transaction data within a database, wherein the historical transaction data includes historical authorization data;
parse the historical transaction data;
extract the historical authorization data from the historical transaction data;
compile the historical authorization data;
build an authorization table using a stored user profile, wherein the stored user profile includes the historical authorization data, wherein the historical authorization data includes at least one of account information and a device identifier, and wherein the stored user profile is built using at least one of the account information and the device identifier;
continuously update the authorization table using the historical authorization data;
receive an authorization data request from a requestor;
compare the authorization data request to the stored user profile;
generate, in response to the authorization data request, an authorization data response; and
transmit the authorization data response to the requestor.

2. The authorization system of claim 1, wherein the processor is further configured to:
calculate, using the historical authorization data, a first authorization date, a first clearing date, a most recent authorization date, a most recent clearing date, a first fraudulent activity date, and a most recent fraudulent activity date; and
store the calculations within the authorization table.

3. The authorization system of claim 1, wherein the processor is further configured to update the authorization table every time the historical transaction data associated with the stored user profile is received.

4. The authorization system of claim 2, wherein the authorization data response includes the first authorization date, the first clearing date, the most recent authorization date, the most recent clearing date, the first fraudulent activity date, and the most recent fraudulent activity date.

5. The authorization system of claim 1, wherein the processor is further configured to compare the authorization data request to the stored user profile using at least one of an account identifier included in the account information and the device identifier.

6. The authorization system of claim 1, wherein the processor is further configured to generate a risk score for the stored user profile based on a time the user account has been active.

7. The authorization system of claim 1, wherein the authorization data response includes a plurality of user accounts.

8. A computer-implemented method for enhancing online authorization processes by centrally storing historical authorization data and analyzing the historical authorization data in real-time for a particular transaction, said method implemented using at least one authorization computing device in communication with a memory, said method comprising:
collecting historical transaction data associated with a user account;
storing the historical transaction data within a database, wherein the historical transaction data includes historical authorization data;
parsing the historical transaction data;
extracting the historical authorization data from the historical transaction data;
compiling the historical authorization data;
building an authorization table using a stored user profile, wherein the stored user profile includes the historical authorization data, wherein the historical authorization data includes at least one of account information and a device identifier, and wherein the stored user profile is built using at least one of the account information and the device identifier;
continuously updating the authorization table using the historical authorization data;
receiving an authorization data request from a requestor;
comparing the authorization data request to the stored user profile;
generating, in response to the authorization data request, an authorization data response; and
transmitting the authorization data response to the requestor.

9. The method of claim 8 further comprising:
calculating, using the historical authorization data, a first authorization date, a first clearing date, a most recent authorization date, a most recent clearing date, a first fraudulent activity date, and a most recent fraudulent activity date; and
storing the calculations within the authorization table.

10. The method of claim 8 further comprising updating the authorization table every time the historical transaction data associated with the stored user profile is received.

11. The method of claim 9, wherein the authorization data response includes the first authorization date, the first clearing date, the most recent authorization date, the most recent clearing date, the first fraudulent activity date, and the most recent fraudulent activity date.

12. The method of claim 8 further comprising comparing the authorization data request to the stored user profile using at least one of an account identifier included in the account information and the device identifier.

13. The method of claim 8 further comprising generating a risk score for the stored user profile based on a time the user account has been active.

14. The method of claim 8, wherein the authorization data response includes a plurality of user accounts.

15. A non-transitory computer-readable storage media having computer-executable instructions embodied thereon, wherein when executed by at least one authorization computing device having at least one processor coupled to at least one memory device, the computer-executable instructions cause the processor to:
collect historical transaction data associated with a user account;
store the historical transaction data within a database, wherein the historical transaction data includes historical authorization data;
parse the historical transaction data;
extract the historical authorization data from the historical transaction data;
compile the historical authorization data;
build an authorization table using a stored user profile, wherein the stored user profile includes the historical authorization data, wherein the historical authorization data includes at least one of account information and a device identifier, and wherein the stored user profile is built using at least one of the account information and the device identifier;
continuously update the authorization table using the historical authorization data;
receive an authorization data request from a requestor;
compare the authorization data request to the stored user profile;
generate, in response to the authorization data request, an authorization data response; and
transmit the authorization data response to the requestor.

16. The computer-executable instructions of claim 15 further cause the processor to:
calculate, using the historical authorization data, a first authorization date, a first clearing date, a most recent authorization date, a most recent clearing date, a first fraudulent activity date, and a most recent fraudulent activity date; and
store the calculations within the authorization table.

17. The computer-executable instructions of claim 15 further cause the processor to update the authorization table every time the historical transaction data associated with the stored user profile is received.

18. The computer-executable instructions of claim 16, wherein the authorization data response includes the first authorization date, the first clearing date, the most recent authorization date, the most recent clearing date, the first fraudulent activity date, and the most recent fraudulent activity date.

19. The computer-executable instructions of claim 15 further cause the processor to compare the authorization data request to the stored user profile using at least one of an account identifier included in the account information and the device identifier.

20. The computer-executable instructions of claim 15 further cause the processor to generate a risk score for the stored user profile based on a time the user account has been active.

21. The computer-executable instructions of claim 15, wherein the authorization data response includes a plurality of user accounts.
